(19) United States
(12) Patent Application Publication
(10) Pub. No.: US 2010/0224575 A1
(43) Pub. Date: Sep. 9, 2010

(54) Device and Method for Processing Cleaning Fluids

(76) Inventors: Martin Nissen, Rude (DE); Klaus-Karl Wasmuht, Ellingen (DE); Kurt Stippler, Marzling (DE); Cornelia Folz, Berlin (DE); Jan Momsen, Flensburg (DE); Timm Kirchhoff, Westerholz (DE)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/668,461

(22) PCT Filed: Jun. 25, 2008
(86) PCT No.: PCT/EP08/05156

§ 371 Date: May 6, 2010

(30) Foreign Application Priority Data
Jul. 16, 2007 (EP) 07013905.0

(51) Int. Cl. B01D 35/22

(52) U.S. Cl. 210/791; 210/196

(57) ABSTRACT

An improved device and a method for processing cleaning fluids, with the device including at least one flushable coarse filter for coarsely filtering the cleaning fluid, a cross-flow filter for finely filtering the coarse filtrate from the at least one coarse filter, a return line through which the coarse filtrate is fed through the cross-flow filter in a circuit, a flushing device for flushing the coarse filter, and a drain branching off from the circuit and connected to the flushing device for flushing the coarse filter with the coarse filtrate fed through the cross-flow filter in the circuit.

### CROSS-REFERENCE TO RELATED APPLICATION

The present application claims the benefit of priority of International Patent Application No. PCT/EP2008/005156, filed Jun. 25, 2008, which application claims priority of European Patent Application No. 07013905.0, filed Jul. 16, 2007. The entire text of the priority application is incorporated herein by reference in its entirety.

### FIELD OF THE DISCLOSURE

The disclosure relates to a method and a device for processing cleaning liquids such as occur in bottle cleaning or in CIP (Cleaning in Process) systems, e.g. in brewhouse cleaning in breweries, and including as suited for cleaning liquids that occur in food processing businesses, pharmaceutical businesses or in plastics recycling businesses.

### BACKGROUND

In breweries, brew vessel cleaning is, just as bottle cleaning, accomplished by means of caustic solutions. Bottles are for example cleaned with a bottle cleaning system as it is roughly schematically shown in FIG. 3. Such bottle cleaning systems 10 for example comprise a pre-caustic bath, a main caustic bath as well as a post-caustic bath as a first rinsing zone as will be described below in detail. In bottle cleaning, however, the condition of the caustic solution deteriorates in spite of the concentration being increased, as an increasing amount of sludge deposits and soluble, insoluble or colloidally dissolved components are contained in the caustic solution. These include among others paper fibers from defibrated labels, coloring pigments, binders from labels, wet strength agents, gluing agents, precipitated sludge from lime components, adhering dirt from bottles, etc. During the cleaning of brewhouse vessels, among others major spent grains and trub residues as well as deposits from the cooking vessels for mash and wort boiling occur.

However, not only caustic solutions are used as cleaning liquid. In particular in CIP systems, acids and disinfectants are also used as cleaning liquids which have to be cleaned; above all, the sludge that deposits at the bottom of the CIP containers must be drained to the channel before each cleaning step.

The processing of the corresponding cleaning liquids is today increasingly accomplished by filtration. In the cleaning systems employed in prior art, however, the problem arises that the filter areas get clogged within a short time, in particular due to the high amounts of impurities, such as paper fibers from label residues, spent grains and trub residues. Such cleaning systems therefore require frequent maintenance and cannot be operated continuously. In particular in the cross-flow filtration of cleaning liquid, large volume feedback containers are used to avoid a concentration of soiling in the cross-flow filter circuit. This has the disadvantage that at the end of the week, the large tank volume has to be discarded. The large volumes in the filtration unit lead to increased heat radiation and reduced availability as it is necessary to fill up the caustic tanks of the bottle cleaner when the filtration system is put into operation, which means considerable downtimes in filling.

### SUMMARY OF THE DISCLOSURE

Starting from this, an aspect underlying the present disclosure is to provide a device and a method for processing cleaning liquids to clean the extremely soiled cleaning liquids easily, environmentally-friendly and continuously.

The combination of a coarse and a fine filter or micro filter, respectively, results in the advantage that the filter arrangement, in particular the cross-flow filter (fine filter) does not get clogged so quickly. In a skillful way, a cross-flow filter is used to this end. The term cross-flow filter is a technical term and designates filters in which the nonfiltrate flows in parallel to and along a filter membrane. A portion of the nonfiltrate penetrates the membrane transversely to the flow direction of the nonfiltrate and can be discharged as filtrate. In the process, solids of the nonfiltrate deposit at the membrane of the filter. With the parallel flow against the membrane, the depositing solids are continuously entrained by the liquid flow, so that a balance between new deposits and cleaning of the membrane is achieved on the membrane.

In accordance with the disclosure, a return line is provided which passes the coarse-filtered cleaning liquid, i. e. the coarse filtrate of the coarse filter, in a circuit through the cross-flow filter. Thus, sufficient flow and high filter efficiency can be ensured. To now prevent the concentration of impurities of the coarse filtrate fed in a circuit in a skillful way, a drain is provided which branches off from the circuit, in particular from the return line, and is connected to a flushing means. Thus, the cleaning liquid concentrated with impurities can be used in a skillful way for flushing the coarse filter. This means that on the one hand a concentration of soiling can be prevented by discharging the coarse filtrate, while on the other hand this discharged coarse filtrate is efficiently used for flushing and does not have to be discarded. The present disclosure makes it possible that no further tank for buffering the accumulation of concentrate is required. This has the further advantage that at the end of the week, no large tank volume has to be discarded. By the system not comprising any large tank volume, the whole system can be pressurized resulting in minimized pumping power. Small filling volumes offer the additional advantage that the availability, for example of a bottle cleaner, increases as refilling of the bottle cleaner is not required when the filtration system is put into operation. It is furthermore advantageous that for example for the processing of post-caustic solution as well as for the processing of main caustic solution of a bottle cleaner the same flow chart is applicable. This permits facilitated production where, depending on the application, only the cross-flow filter, i. e. the pore size of the corresponding membrane, has to be adapted. Cleaning liquids are meant to include caustic solution as well as cleaning acid or disinfectant.

Advantageously, the device comprises at least two coarse filters arranged in parallel which can be flushed alternately. Thereby, a continuous process can be guaranteed as even if one of the coarse filters is being flushed and cleaned, the second coarse filter is in use. As the coarse filtrate fed in the circuit is used for flushing, flushing can thus be frequently performed thus improving filter efficiency. The process does not have to be interrupted.

Advantageously, the coarse filter filters particles having a size of >50 μm. Depending on the application, the cross-flow filter has a pore size within a range of <=2 μm, preferably <=0.4 μm. According to a preferred embodiment, a disk filter can be employed as coarse filter. Such a disk filter can be easily flushed.

According to a preferred embodiment, the device processes as caustic solution main caustic solution from a main caustic bath of a bottle cleaner and comprises a fine filtrate line which supplies the fine filtrate from the cross-flow filter again to the main caustic bath. The device according to the disclosure is simultaneously also suitable for processing post-caustic solution from a post-caustic bath of a bottle cleaner and then comprises a fine filtrate line which supplies the fine filtrate from the cross-flow filter again to the post-caustic bath.

In the processing of main caustic solution, the circuit can comprise a further branch line for discarding a portion of the coarse filtrate fed in the circuit. That means, if the concentration of impurities in the cross-flow filter circuit becomes too high, a portion of the coarse filtrate fed in the circuit can be branched off and discarded in addition, so that the concentration of impurity is reduced. Thus, an excessive gel layer formation on the membrane surface of the cross-flow filter and premature clogging can be prevented.

In the cleaning of post-caustic solution, the circuit can also comprise a further branch line for supplying a portion of the coarse filtrate fed in the circuit to a pre-caustic bath. Thus, the concentration of impurities in the membrane filtration circuit can be prevented in an advantageous manner, where the coarse filtrate can be simultaneously used for the pre-caustic bath as the caustic solution in the pre-caustic bath does not have to be filtered so thoroughly.

According to the present disclosure, caustic solution or acid or a disinfecting liquid from a CIP system can also be processed as cleaning liquid, wherein the fine filtrate is then supplied to a corresponding caustic solution or acid or disinfecting liquid tank.

In the method according to the disclosure, a certain portion of the coarse filtrate fed in the circuit can be continuously discharged. The discharged portion of the coarse filtrate can also be discharged at certain intervals in a clocked manner during the filtration process.

### BRIEF DESCRIPTION OF THE DRAWINGS

The present disclosure will be illustrated below in greater detail with reference to the following figures.

FIG. 1 schematically shows the flow chart of a device according to the present disclosure.

FIG. 2a schematically shows a section through a disk filter which is used in the device according to the disclosure.

FIG. 2b schematically shows a plan view of a disk of the disk filter shown in FIG. 2a.

FIG. 3 schematically shows the different stages of a bottle cleaning system.

FIG. 4 roughly schematically shows a section through a cross-flow filter.

FIG. 5 shows a section along line I-I in FIG. 4.

FIG. 6 shows, in a perspective representation, a multitube membrane filter candle which is employed, for example, in the filter shown in FIG. 4.

FIG. 7 schematically shows the basic diagram of a CIP system.

### DETAILED DESCRIPTION OF THE PREFERRED EMBODIMENT

According to the present disclosure, a flushable coarse filter, for example a disk filter 2, is used in combination with across-flow filter 3 for processing the soiled cleaning liquids occurring in breweries.

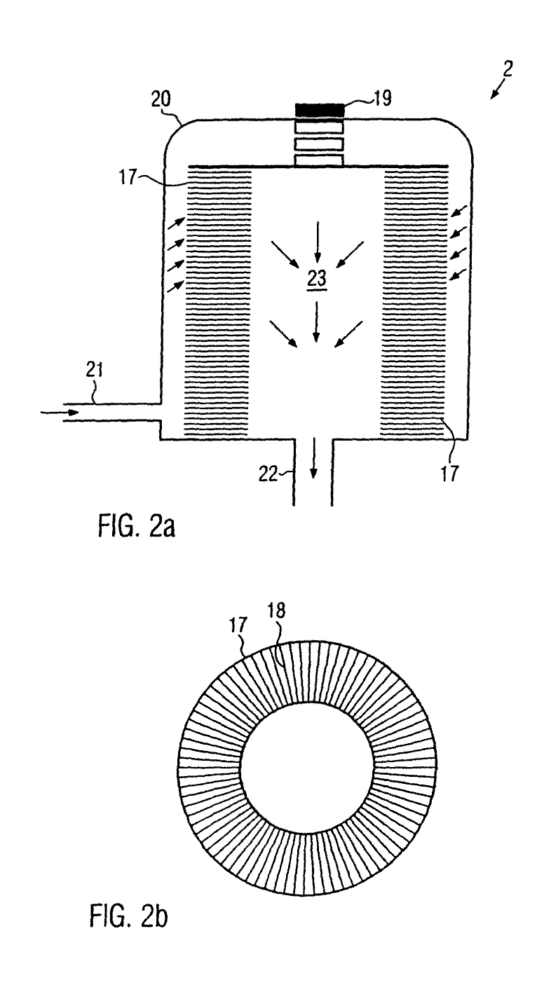

A disk filter is shown, for example, in FIGS. 2a and 2b. The disk filter comprises a filter housing 20 as well as a nonfiltrate supply 21 and a coarse filtrate outlet 22. According to the present disclosure, the cleaning liquid is supplied to the disk filter 2 via the supply 21. The disk filter 2 comprises a plurality of filter disks 17 arranged one upon the other. As can be taken from FIG. 2b, the filter disks 17 are designed as filter rings. The disks 17 are pressed together by the spring force of the spring 19. The disks comprise a ribbing 18 at least on one side. Advantageously, the grooves or elevations 18 extend essentially radially outwards. The ribbing of the stacked disks 17 thus forms the filter pores through which the nonfiltrate passes the filter. Preferably, plastic disks are used for this. The nonfiltrate is introduced for filtration via the supply 21 for example tangentially from outside and passes the pores between the individual filter disks 17 as indicated by the arrows. The filtrate is then discharged from the interior 23 of the disk filter via the outlet 22. During flushing, for example an air-liquid mixture is passed into the interior 23 and pressed out of the filter between the filter disks opposite to the direction of arrow. Simultaneously, the squeeze of the disks 17 is released by reducing the spring force. The filter pores are thereby enlarged and the individual disks are simultaneously rotated by the flushing. Thereby, an optimum cleaning of the filter area is ensured.

Preferably, the filter fineness is about 50 μm. With a filter fineness of 100 μm, about 50% of the fibers are still separated during caustic filtration.

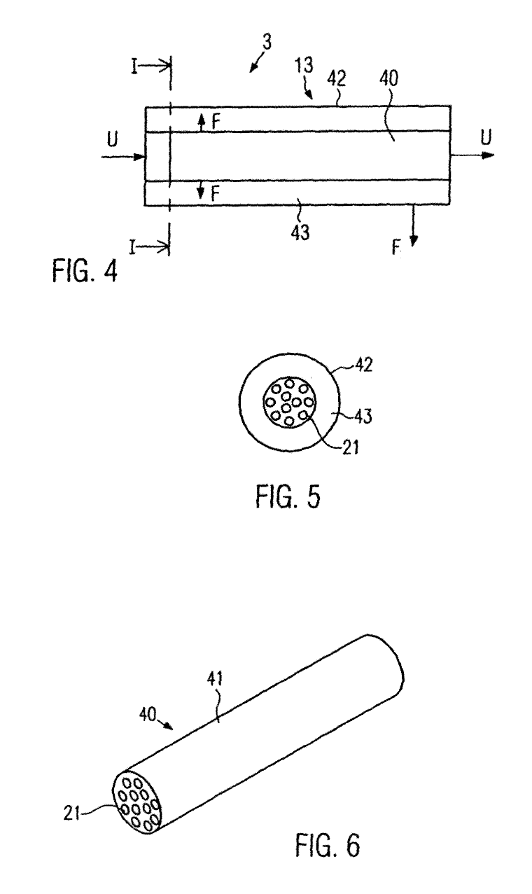

As is illustrated in connection with FIGS. 4-6, across-flow filter 3 is used for fine filtration or micro filtration. For the continuous operation with small cut-offs, surface filtration with membranes as a filter layer forms a reasonable initial combination. In cross-flow filtration, the liquid to be filtered, that means here the coarse filtrate from the coarse filter 2a/b, flows in parallel along the filter membrane. The overpressure prevailing in the system provides for the penetration of a portion of the nonfiltrate, here the coarse filtrate, through the membrane transversely to the flow direction of the coarse filtrate. In the process, the entrained solids of the nonfiltrate, i.e. the coarse filtrate, deposit on the membrane. With the parallel flows against the membrane, the depositing solids are continuously entrained by the liquid matter, and a balance between new deposits and cleaning of the membrane is achieved on the membrane. The depositing matters on the membrane which are not entrained by the liquid flow form the so-called gel layer.

In FIGS. 4-6, one possible embodiment of such a cross-flow filter 3 is shown, where the filter here comprises a pressure housing 42 as well as at least one multitube membrane filter candle 40. Between the membrane filter candle 40 and the pressure housing 42, a filtrate chamber 43 is formed. The multitube membrane filter candle 40 comprises several tubes 21 extending in the longitudinal direction through the filter candle 40, as shown in FIGS. 5 and 6 more in detail. The filter candle can be embodied of a ceramic material, where a membrane layer of only a few pm can be arranged on the inner surface of the tube. The pore size is within a range of <=2 μm, preferably <=0.4 μm, depending on the application. In filtration, nonfiltrate, here coarse filtrate from the coarse filter 2a/b, enters the tubes 21 of the filter candle 40, passes through the membrane in the tubes 21 as well as the ceramics of the filter candle and leaves the surface 41 of the filter candle 40 as filtrate and enters the filtrate chamber 43 where it can be removed as filtrate. The nonfiltrate which flows through the tubes 21 leaves the cross-flow filter 3 and can be supplied again to the cross-flow filter in the circuit to maintain a nonfiltrate flow through the filter as will be illustrated below. As in the cleaning in breweries hot cleaning liquids having temperatures of up to 90° C. are also used, a cross-flow filter arrangement of ceramic material is particularly suited.

The device according to the disclosure and the method according to the disclosure can be used, for example, for cleaning liquids from CIP systems, e.g. for brewhouse cleaning or for cleaning in the bottling department.

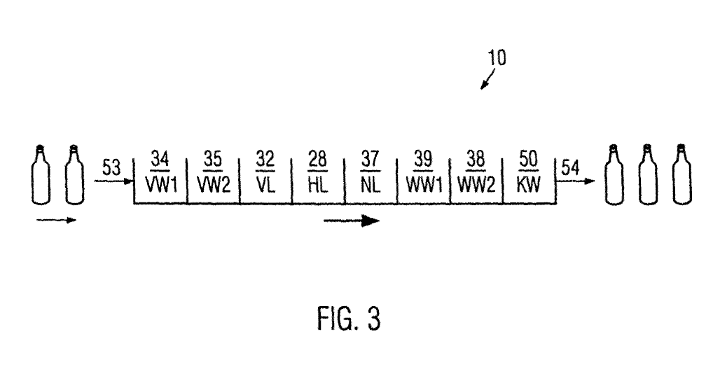

The method according to the disclosure as well as the device according to the disclosure will be illustrated more in detail below in particular in connection with the bottle cleaning system represented in FIG. 3.

FIG. 3 shows the main stages of a bottle cleaner with a bottle infeed 53, which can include a bottle cleaning system 10 comprising a pre-caustic bath 32, a main caustic bath 28, as well as a post-caustic bath 37 as a first rinsing zone. After the leftovers have been emptied, the bottles subsequently pass the pre-soak 34 and the pre-soak 35 and then pass the pre-caustic bath. Then, the longest and most intensive processing is effected in the main caustic bath 28 where most of the dirt and most of the impurities loosen. This is also true for the labels and the label glue. In a post-caustic bath 37, i.e. in a first rinsing zone, the bottles are again cleaned inside and outside and can then be sprayed with warm water inside and outside by a spraying means 38/39. Subsequently, a treatment with cold and fresh water is performed in a corresponding means 50. At the end, the bottles are discharged via a bottle discharge 54.

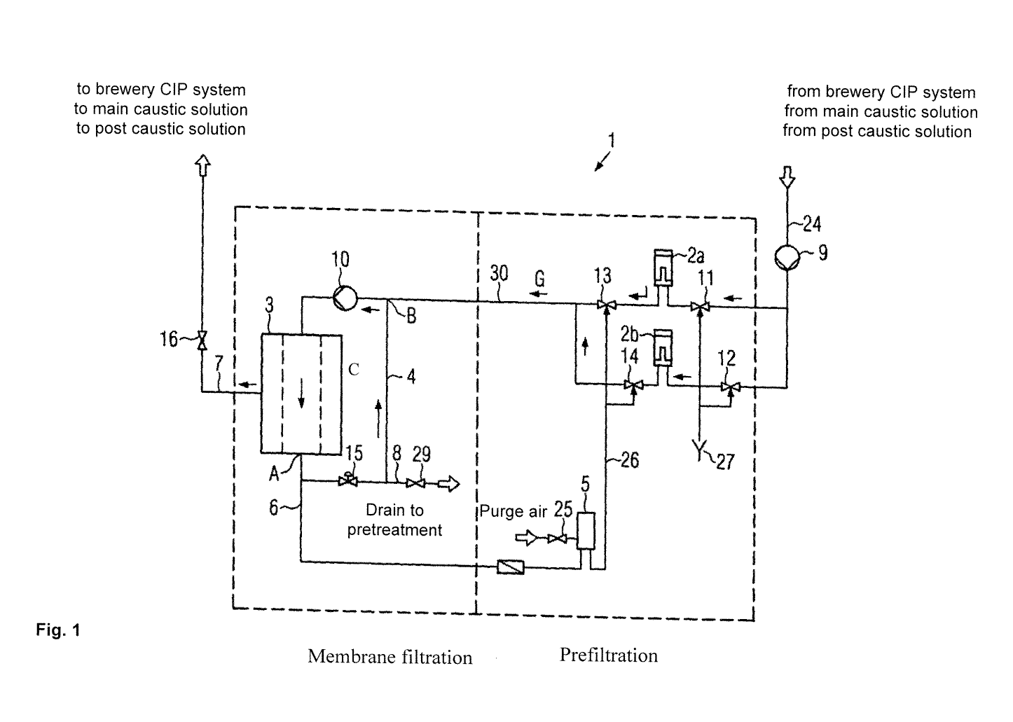

The device according to the disclosure for processing cleaning liquid, here e.g. main caustic solution or post-caustic solution or a cleaning liquid from a CIP system, is represented in FIG. 1.

Below, the disclosure is described for caustic solution, e.g. main caustic solution or post-caustic solution. The method or the device described in connection with FIG. 1, however, is also suited for another cleaning liquid, e.g. a brewery CIP system.

The device according to the disclosure is connected to a reservoir for the caustic solution, for example a main caustic bath or a post-caustic bath, via a line 24. Furthermore, the device comprises a pump 9 via which the caustic solution can be pumped into the device according to the disclosure. Moreover, the device 1 according to the disclosure here comprises two coarse filters 2a/b which are arranged in parallel to each other. The coarse filters 2a/b are for example disk filters as they have been illustrated more in detail in connection with FIGS. 2a/b. The coarse filters 2a/b filter out particles of a size of >50 μm. Though it is not shown here, several coarse filters can also be arranged in parallel to each other and be alternately operated for cleaning purposes. Though it is not shown here, several coarse filters 2a could also be connected in parallel and in series to several coarse filters 2b in series.

After coarse filtration, the coarse filtrate is passed to the membrane filtration as shown by arrow G. A pump 10 is arranged upstream of the cross-flow filter 3 which has been illustrated for example in connection with FIGS. 5-6. The cross-flow filter 3 comprises a filtrate drain 7 in which in turn the valve 16 is arranged. The device further comprises a return line 4 through which the coarse filtrate is fed through the cross-flow filter 3 in the circuit C. A control valve 15 is provided for adjusting the flow. Thus, the coarse filtrate moves at the membrane or the membranes through the cross-flow filter 3, leaves the filter 3 and is supplied again to the cross-flow filter 3 in the circuit via the pump 10 together with new coarse filtrate from the coarse filters 2a/b. The device further comprises a flushing means 5 for flushing the coarse filters 2a/b. As a rinsing liquid, the coarse filtrate circulating in the circuit C is here advantageously used. For this, a drain 6 is provided which is connected to the flushing means 5. Thus, a predetermined portion of the nonfiltrate or coarse filtrate fed in the circuit is passed into a rinsing container of the flushing means 5. The flushing amounts are about 0.1%-0.5% of the throughput, e.g. with a filter amount in a size range of 1-10 m³ caustic solution per hour. By draining the coarse filtrate from the cross-flow filter, a concentration of impurities is prevented, while this drained coarse filtrate can be used for flushing in a skillful way. The flushing means 5 further comprises a supply for purge air with a corresponding valve 25. The air-coarse filtrate mixture can then be pressed backwards into the coarse filters 2a/b via the pipeline 26, whereupon the same is conveyed to the drainpipe 27 together with the dirt. For this, corresponding 3/2-way valves 13, 14, 11, 12, are provided which can be adjusted such that one filter each is being flushed while the other one is in operation.

Upstream and downstream of the filters 2a, b, corresponding pressure sensors can be arranged which detect the differential pressure upstream and downstream of the corresponding coarse filters 2a, b which is compared to a set value. If the measured differential pressure exceeds the predetermined set value, a flush process is initiated for a corresponding filter.

The drain 6 here branches off from the circular return line 4. However, it would also be possible for this drain 6 to be directly connected to the outlet of the cross-flow filter. Advantageously, the drain 6 is arranged in an area from the rear end A of the cross-flow filter 3 to the point B where new coarse filtrate is supplied to the circuit C from the filters 2a/b. The device can comprise a further branch line 8 for discarding a portion of the coarse filtrate fed in the circuit. If during cleaning of the main caustic solution for example the concentration in the circuit C is too high, a certain portion can be additionally discarded via the drain 8. The valve 29 is provided to this end. Upstream and downstream of the cross-flow filter module, pressure sensors (not shown) can be arranged which measure the pressure differential, i.e. the transmembrane pressure. This differential pressure is compared to a set value. If the detected differential pressure exceeds the set value, coarse filtrate fed in the circuit C is branched off.

In the processing of post-caustic solution, the coarse filtrate fed in the circuit can also be passed to the pretreatment, i.e. for example to the pre-caustic bath, via the branch line 8. Coarse filtration is sufficient for the quality of the caustic solution in the pre-caustic bath. Moreover, it is here advantageous that the surfactants have not been filtered out and remain in the caustic solution in the coarse filtrate. The branch line 8 is here connected to the return line 4, however, it can also be adjacent to the cross-flow filter as described above.

The method according to the disclosure will first be illustrated in connection with the cleaning of main caustic solution of a main caustic bath 28 of a bottle cleaner 10. First, soiled caustic solution from the main caustic bath 28 is pumped into the device 1 according to the disclosure via a pump 9 via the line 24. In the process, soiled caustic solution passes the coarse filters 2a/b, the valves 11/12, 13/14 being adjusted such that the caustic solution flows through the filter to the line 30 in the direction of arrow. The coarse filters 2a/b are here uncoupled from the rinsing line 26. The coarsely filtered caustic solution is then pumped into the cross-flow filter 3 via the pump 10. Transverse to the flow direction of the coarse filtrate, the coarse filtrate passes through the membrane and is thus finely filtered. The fine filtrate is returned to the main caustic bath 28 via the line 7 with the valve 16 being open. The coarse filtrate which passes the cross-flow filter 3 is fed in the circuit C via the return line 3, new coarse filtrate being added to the circuit at point B. To prevent a concentration of the impurities in the circuit C, a certain portion of the coarse filtrate is supplied to the flushing means 5 or a rinsing container of the flushing means 5 via the line 6. In the process, a certain portion can be continuously removed from the circuit C, or else a certain amount of coarse filtrate can be removed at certain intervals in a clocked manner. This removed coarse filtrate which is then stored in the container of the flushing means 5 can then be advantageously used for flushing one of the two coarse filters 2a/b.

To flush the coarse filter 2a/b, the valve 13 is for example adjusted such that the flush line 26 is connected with the coarse filter 2a, the coarse filter 2a, however, is no longer connected with the line 30. Furthermore, the valve 11 is adjusted such that the coarse filter 2a is connected with the drainpipe 27, however no longer with the line to the pump 9. For flushing, air is blown into the rinsing container. The air-coarse filtrate mixture is then pressed backwards through the pipeline 26 through the filter 2a and then conveyed to the drainpipe together with the dirt. While the coarse filter 2a is being flushed, the valves 12/14 remain in a position in which the filter 2b takes over coarse filtration, while the caustic solution is guided in direction of arrow into the line 30. After flushing has been performed, the valves 11/13 are returned to their working position so that coarse filtration can be again also accomplished via the filter 2a. Subsequently, the coarse filter 2b can then be flushed in the same manner by correspondingly adjusting the valves 11/12/13/14. As described above, the flushing process for a coarse filter 2 can be initiated if the measured pressure differential upstream and downstream of the coarse filter exceeds a predetermined set value. It is thus ensured that the caustic solution can be continuously processed and the process does not even have to be interrupted during flushing. By the fact that a concentration of the caustic solution in the cross-flow filter circuit C is simultaneously prevented, the cross-flow filter does not get clogged, so that continuous operation is possible. If the concentration in the circuit C becomes too high, coarse filtrate can be additionally removed from the circuit C via the line 8 by correspondingly opening the valve 29. This removed coarse filtrate is then discarded.

Advantageously, concentration can here be prevented without any large feed container being necessary. Thus, small volumes can be realized in the filtration unit resulting in minimized heat radiation. Furthermore, the complete system can be pressurized resulting in minimized pumping power. Small filling volumes have the additional advantage that the availability of the bottle cleaner is increased as refilling of the bottle cleaner is not required when the filtration system is put into operation.

During the cleaning of post-caustic solution, the method as it was illustrated in connection with the main caustic solution is performed. Here, too, coarse filtrate from the membrane filtration circuit is used for flushing as was illustrated above. In difference to the previous embodiment, however, coarse filtrate is, if necessary, removed via the line 8 and not discarded, but fed to a pre-caustic bath 32.

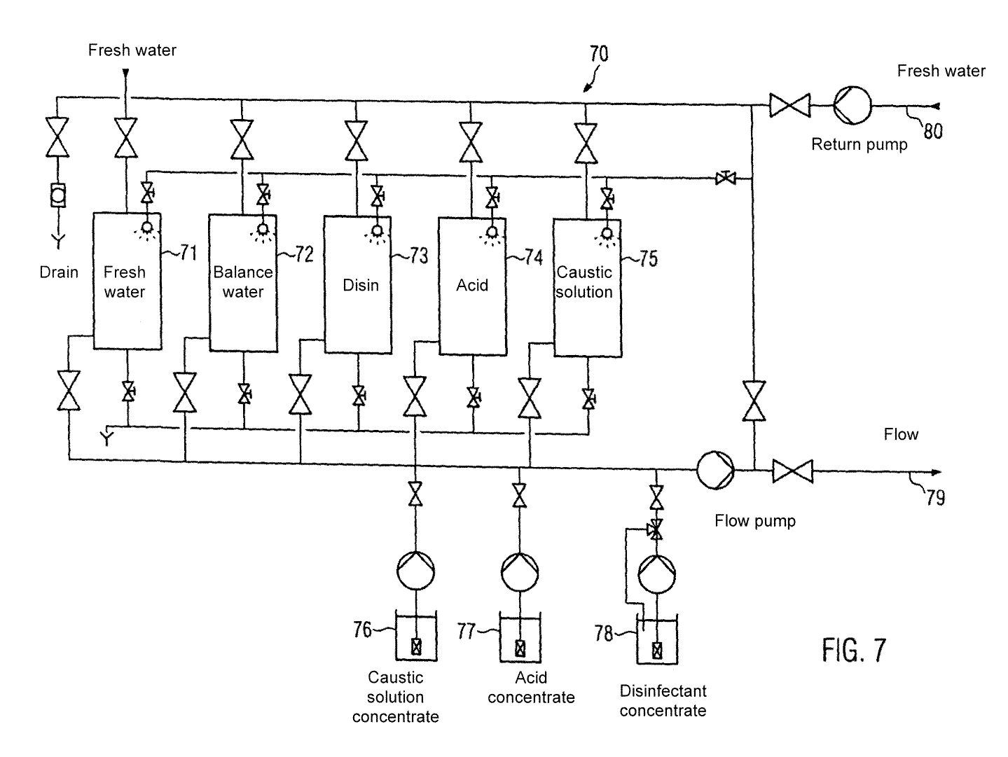

FIG. 7 shows the basic diagram of a balance tank CIP system (Cleaning in Process). Such a system 70 comprises a fresh water tank 71, a balance water tank 72, a disinfecting liquid tank 73, an acid tank 74 as well as a caustic solution tank 75. Furthermore, a CIP system can also comprise a supply for caustic concentrate 76, for acid concentrate 77 and for disinfecting concentrate 78. The detergent concentrates 76, 77, 78 are diluted with the cleaning water to obtain the corresponding concentration in the corresponding disinfecting liquid, acid and caustic solution tanks 73, 74 75, respectively. Via the line 79, the corresponding cleaning liquid can be supplied from the tanks 73, 74, 75 to the object to be cleaned (tanks with cleaning apparatus, pipelines, etc.) and returned to the corresponding tanks via the return line 80. Via a non-depicted line 24, the corresponding cleaning liquid can then be supplied from the tanks 73 or 74 or 75 to the device shown in FIG. 1. The fine filtrate can then be again supplied to the respective tank 73, 74 or 75 via the fine filtrate line 7 shown in FIG. 1. The coarse filtrate discharged via the outlet line 8 in FIG. 1 can be discarded.

It is advantageous that the same flow chart can be used for the main caustic and post-caustic cleaning of a bottle cleaner 10 and for CIP systems 70. This brings about advantages in terms of manufacture as for all applications the same device can be built which only differs in the pore size of the membrane of the cross-flow filter 3. Thus, the cleaning liquid can be cleaned by an inexpensive device. By the coarse filtrate discharged in the membrane filtration circuit not being completely discarded but used for flushing, process media as well as energy can be saved.

The previous embodiments have been described in particular in connection with cleaning liquids which in particular occur in bottle cleaners and CIP systems in breweries. The method according to the disclosure and the device according to the disclosure, however, can also be used for processing cleaning liquids in other food processing businesses (e.g. milk or juice). Cleaning liquids occurring in pharmaceutical businesses can also be processed according to the present disclosure. In plastics recycling businesses, in particular for cleaning cleaning liquids occur which can be processed according to the present disclosure.

In plastics recycling, for example: in the first stage of wet cleaning, the previously crushed bottles (flakes) are soaked in process water and supplied to hot caustic washing. There, the PET is washed hot with caustic solution and surfactants and freed from adhering dirt, labels and glue residues. The detergent caustic solution is processed according to the disclosure.

Then, the PET can be repeatedly rinsed hot in a further stage. In this process stage as well as for the detergent caustic preparation, demineralized fresh water is used, otherwise, processed process water is used. In this step, too, processing according to the disclosure is possible.

1. Device for processing cleaning liquids, comprising:
at least one flushable coarse filter for coarse filtration of the cleaning liquid,
one cross-flow filter for fine filtration of the coarse filtrate from the at least one coarse filter,
one return line through which the coarse filtrate is fed in the circuit through the cross-flow filter,
one flush means for flushing the coarse filter,
one drain branching off from the circuit and connected to the flushing means for flushing the coarse filter with the coarse filtrate fed in the circuit through the cross-flow filter.

2. Device according to claim 1, and wherein at least two coarse filters are arranged in parallel and can be flushed alternately.

3. Device according to claim 1, wherein the coarse filter filters off particles of a size of >50 μm.

4. Device according to claim 1, wherein the cross-flow filter has a pore size within a range of <=2 μm.

5. Device according to claim 1, wherein the device processes as cleaning liquid main caustic solution from a main caustic bath of a bottle cleaner and comprises a fine filtrate line which feeds the fine filtrate from the cross-flow filter again to the main caustic bath.

6. Device according to claim 1, wherein the device processes as cleaning liquid post-caustic solution from a post-caustic bath of a bottle cleaner and comprises a fine filtrate line which feeds the fine filtrate from the cross-flow filter again to the post-caustic bath.

7. Device according to claim 5, wherein the circuit comprises a further branch line for discarding a portion of the coarse filtrate fed in the circuit.

8. Device according to claim 6, wherein the circuit comprises a further branch line to supply a portion of the coarse filtrate fed in the circuit to a pre-caustic bath.

9. Device according to claim 1, wherein the coarse filter is a disk filter.

10. Device according to claim 1, wherein the device processes one of caustic solution or acid or disinfecting liquid from a cleaning in process system and comprises a fine filtrate line which supplies the fine filtrate to a corresponding caustic solution or acid or disinfecting liquid tank.

11. Method for processing cleaning liquids, comprising:
coarsely filtering cleaning liquid by means of a coarse filter,
feeding the coarse filtrate through a cross-flow filter in the circuit for generating fine filtrate through the cross-flow filter, and
branching off a portion of the coarse filtrate fed in the circuit and supplying the branded off portion to a flushing means for flushing the coarse filter.

12. Method according to claim 11, comprising:
processing as cleaning liquid main caustic solution from a main caustic bath of a bottle cleaner and supplying the generated fine filtrate from the cross-flow filter to the main caustic bath.

13. Method according to claim 11, comprising:
processing as cleaning liquid post-caustic solution from a post-caustic bath of a bottle cleaner and supplying the fine filtrate from the cross-flow filter to the post-caustic bath.

14. Method according to claim 11, comprising:
processing as cleaning liquid one of detergent caustic solution or acid or disinfecting liquid from a cleaning in process system, and supplying the fine filtrate from the cross-flow filter to one of a corresponding caustic solution or acid or disinfecting liquid tank.

15. Method according to claim 12, wherein a portion is furthermore branched off from the coarse filtrate fed in the circuit and discarded.

16. Method according to claim 13, wherein a portion is furthermore branched off from the coarse filtrate fed in the circuit and supplied to a pre-caustic bath.

17. Method according to, claim 11, and continuously discharging a portion of the coarse filtrate fed in the circuit.

18. Method according to claim 17, and discharging the discharged portion of the coarse filtrate in a clocked manner.

19. Method according to claim 11, wherein the cleaning liquid is filtered one of alternately or simultaneously by means of at least two coarse filters arranged in parallel.

20. Method according to claim 11, and processing cleaning liquids that occur in breweries, in food processing businesses, in pharmaceutical businesses or in plastics recycling businesses.

21. Device according to claim 4, wherein the pore size is within a range of <=0.4 μm.
